(19) United States
(12) Patent Application Publication
(10) Pub. No.: US 2026/0263910 A1
(43) Pub. Date: Sep. 10, 2026

(54) LOTTERY TICKET SELLING SYSTEM HAVING A LOTTERY TICKET PRINTER SENSOR THAT DETECTS THE PRINTING OF DRAW LOTTERY TICKETS BY A DRAW LOTTERY TICKET PRINTER

(71) Applicant: Brightstar Global Solutions Corporation, Providence, RI (US)

(72) Inventor: Robert Corvese, Warwick, RI (US)

(21) Appl. No.: 19/071,228

(22) Filed: Mar. 5, 2025

(51) Int. Cl. A63F 3/06

(52) U.S. Cl. CPC A63F 3/0655

(57) ABSTRACT

A lottery ticket selling system including a wager details display device, a ticket courier server causes a display of a code associated with an ordered draw lottery ticket by the wager details display device, a lottery terminal and associated scanner, a lottery ticket printer, and a lottery ticket printer sensor such as optical sensor configured to indicate that the lottery printer printed a first draw lottery ticket associated with the code, and cause the ticket courier server to remove a display of a code associated with that draw lottery ticket by the wager details display device.

### BACKGROUND

The present disclosure relates to a lottery ticket selling system having a lottery ticket printer sensor that detects the printing of draw lottery tickets by a lottery ticket printer.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to a lottery ticket selling system including: a wager details display device; a ticket courier server that responsive to receiving an order for a draw lottery ticket from an electronic player device with a courier mobile application, causes a display of a code associated with the draw lottery ticket by the wager details display device; a lottery terminal and associated scanner; a draw lottery ticket printer; and a lottery ticket printer sensor. The lottery ticket printer sensor is positioned to sense one of: a draw lottery ticket exiting a part of the draw lottery ticket printer, the draw lottery ticket after it exits the part of the draw lottery ticket printer, the draw lottery ticket held by the draw lottery ticket printer, and an action of the draw lottery ticket printer when or after the draw lottery ticket printer prints the draw lottery ticket. The lottery ticket printer sensor includes a transmitter, a processor, and a memory device that stores a plurality of instructions, which when executed by the processor cause the processor to: receive a first signal from the sensor that indicates that the draw lottery printer printed the draw lottery ticket corresponding to the code, and send a second signal, via the transmitter, which indicates that the draw lottery ticket printer printed the draw lottery ticket and that causes a removal of the display of the code associated with that draw lottery ticket by the wager details display device.

In various other embodiments, the present disclosure relates to a lottery ticket selling system including: a wager details display device; a ticket courier server that responsive to receiving an order for a draw lottery ticket, causes a display of a code associated with an ordered draw lottery ticket by the wager details display device; a lottery terminal and associated scanner; a draw lottery ticket printer; and a lottery ticket printer sensor. The lottery ticket printer sensor includes a transmitter, a processor, and a memory device that stores a plurality of instructions, which when executed by the processor cause the processor to: receive a first signal from the sensor that indicates a physical sensing of the draw lottery printer printing a draw lottery ticket, and send a second signal, via the transmitter, which indicates that the draw lottery ticket printer printed the draw lottery ticket and that causes a removal of the display of the code associated with that draw lottery ticket from the wager details display device.

In various other embodiments, the present disclosure relates to a lottery ticket selling system including: a wager details display device; a ticket courier server that responsive to receiving a first order for a first draw lottery ticket, causes a display of a first code associated with an ordered first draw lottery ticket by the wager details display device; a lottery terminal and associated scanner; a draw lottery ticket printer; and a lottery ticket printer sensor. The sensor includes an optical sensor, a transmitter, a processor, and a memory device that stores a plurality of instructions, which when executed by the processor cause the processor to: receive a first signal from the optical sensor that indicates that the draw lottery printer printed a first draw lottery ticket associated with the first code; send a second signal, via the transmitter, which indicates that the draw lottery ticket printer printed the first draw lottery ticket and that causes a removal of the display of the first code associated with that first draw lottery ticket by the wager details display device; receive a third signal from the optical sensor that indicates that the draw lottery printer printed a second draw lottery ticket associated with the second code; and send a fourth signal, via the transmitter, which indicates that the draw lottery ticket printer printed the second draw lottery ticket and that causes a removal a display of the second code associated with the second draw lottery ticket by the wager details display device.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a known lottery ticket selling system.

FIG. 3 is a diagrammatic perspective view of an example lottery ticket selling system having a lottery ticket printer sensor that detects the printing of draw lottery tickets by a lottery ticket printer of the system in accordance with one example embodiment of the present disclosure.

FIG. 4 is a perspective view of the lottery ticket printer sensor that detects the printing of the draw lottery tickets by the lottery ticket printer of the lottery ticket selling system of FIG. 3.

FIG. 5 is a flow diagram showing one example method of operating the lottery ticket selling system of FIG. 3.

### DETAILED DESCRIPTION

In various embodiments, the present disclosure relates to a lottery ticket selling system and method of operating the lottery ticket selling system, wherein the lottery ticket selling system includes a lottery ticket printer sensor that detects the printing of draw lottery tickets by a draw lottery ticket printer of the system. The lottery ticket printer sensor confirms that each ordered and purchased draw lottery ticket is printed by the draw lottery ticket printer before the system proceeds to the process of generating and printing a next ordered and purchased draw lottery ticket.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for selling various other draw lottery tickets.

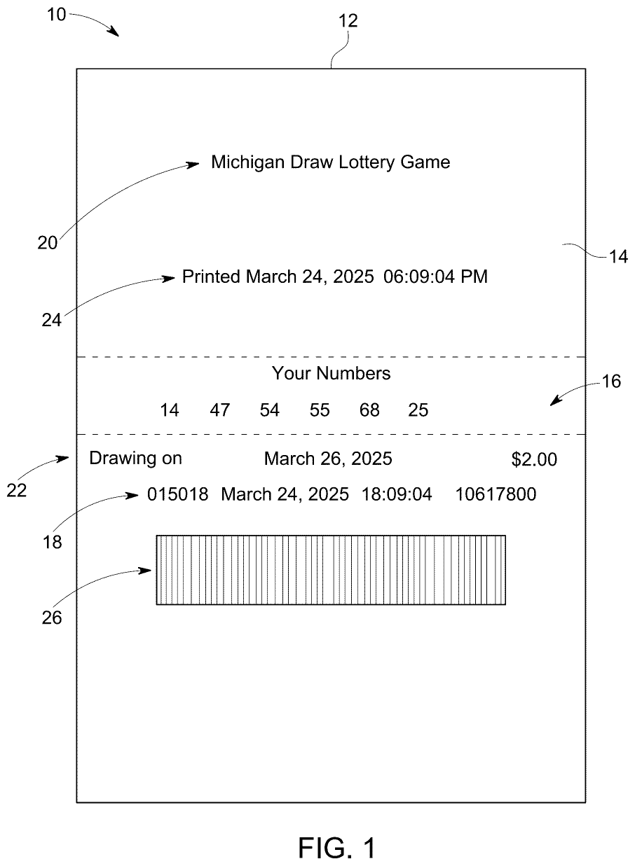

An example physical draw lottery ticket 10 is shown in FIG. 1. This example draw lottery ticket includes: (1) a ticket substrate 12; (2) a front surface 14 of the ticket substrate 12; (3) draw lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Mar. 26, 2025) and includes a single set of player numbers 16 (i.e., player numbers for the single play of the draw lottery game). The draw lottery ticket information in this example includes player numbers 16, a draw lottery ticket identifier 18 that uniquely identifies the draw lottery ticket 10, a game identifier 20 that identifies the draw lottery game, a draw date 22 associated with the draw lottery ticket 10, and a print date 24 on which the draw lottery ticket 10 was printed. The draw lottery ticket information can include text, a draw lottery ticket number such as the draw lottery ticket identifier 18, a draw lottery ticket barcode such as barcode 26, and/or other draw lottery ticket information that is in either or both human readable and machine-readable forms. The draw lottery ticket's barcode 26 is configured to be scanned by a barcode reading device to enable redemption of the draw lottery ticket.

Additionally, for a better understanding of the present disclosure, an example known system and method employed for selling draw lottery tickets is also now described.

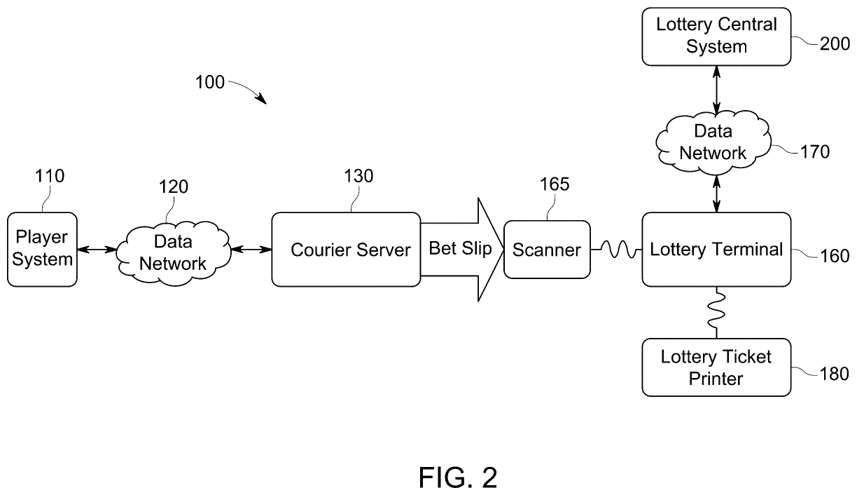

In various jurisdictions (such as states) that do not permit the remote electronic purchase of draw lottery tickets (such as via a website), a draw lottery ticket system 100 using a courier service has been employed. Turning to FIG. 2, the draw lottery ticket system 100 includes: (a) an electronic player system 110 with a courier mobile application downloaded thereon; (b) a courier server 130; (c) a lottery terminal 160; (d) a scanner 165 that is part of or that is associated with the lottery terminal 160; (e) a draw lottery ticket printer 180; and (f) a central lottery system 200. The electronic player system 110 and the courier server 130 are configured to communicate via a suitable data network 120. The lottery terminal 160 and the scanner 165 are configured to communicate via hard wire such as an USB connector. The lottery terminal 160 and the draw lottery ticket printer 180 are configured to communicate via hard wire such as an USB connector. The lottery terminal 160 and the lottery central system 200 are configured to communicate via a data network 170.

The electronic player system 110 includes an electronic player device such as a smartphone with the courier mobile application downloaded thereon. The courier server 130 includes a server configured to receive draw lottery game bet details from the electronic player system 110 via the courier mobile application and to generate a suitable bet slip for a play of the draw lottery game based on the draw lottery game bet details. The bet slip includes the player numbers for a selected play of a selected draw lottery game. The courier server 130 causes the bet slip to be printed such that the bet slip can be scanned by the scanner 165. A human courier processing clerk takes the physical printed paper bet slip for the play of the draw lottery game to the lottery terminal 160 to scan the physical printed paper bet slip. The scanner 165 scans the bet slip and the lottery terminal 160 uses that bet slip scan data to determine the player numbers for the play of the draw lottery game and to create the draw lottery ticket for the player. The lottery terminal 160 causes the draw lottery ticket printer 180 to print out the draw lottery ticket with the player numbers. The operator of the lottery terminal 160 also collects the payment for the draw lottery ticket from the courier processing clerk and provides the printed draw lottery ticket to the courier processing clerk. The courier processing clerk takes the physical printed bet slip and the physical printed draw lottery ticket back to the courier processing center. The courier processing clerk scans the physical printed draw lottery ticket using a courier scanning system (not shown) connected to the courier server 130. The courier server 130 links the scanned draw lottery ticket back to a player account established through the courier mobile application. The courier server 130 then makes the scanned draw lottery ticket available for the player to view via the courier mobile application on the electronic player system 110. The courier processing clerk places the physical printed bet slip and the physical printed draw lottery ticket in secure courier storage locations for storage if needed at a later time.

After the draw for the play of the draw lottery game takes place, if the player's draw lottery ticket is a winning draw lottery ticket and the winning amount is less than $600, the courier server automatically credits the winning amount for the player's draw lottery ticket to the player's account. The courier service can then retrieve and redeem the stored actual winning physical printed draw lottery ticket at a location having a lottery terminal. After the draw for the draw lottery game takes place, if the player's draw lottery ticket is a winning draw lottery ticket and the winning amount is $600 or more, a courier processing clerk retrieves the stored winning physical player draw lottery ticket from the courier storage location and provides that physical printed draw lottery ticket to the player so that the player can redeem that draw lottery ticket and obtain the winning amount.

The present disclosure is configured to be employed with various improvements to the courier system described above.

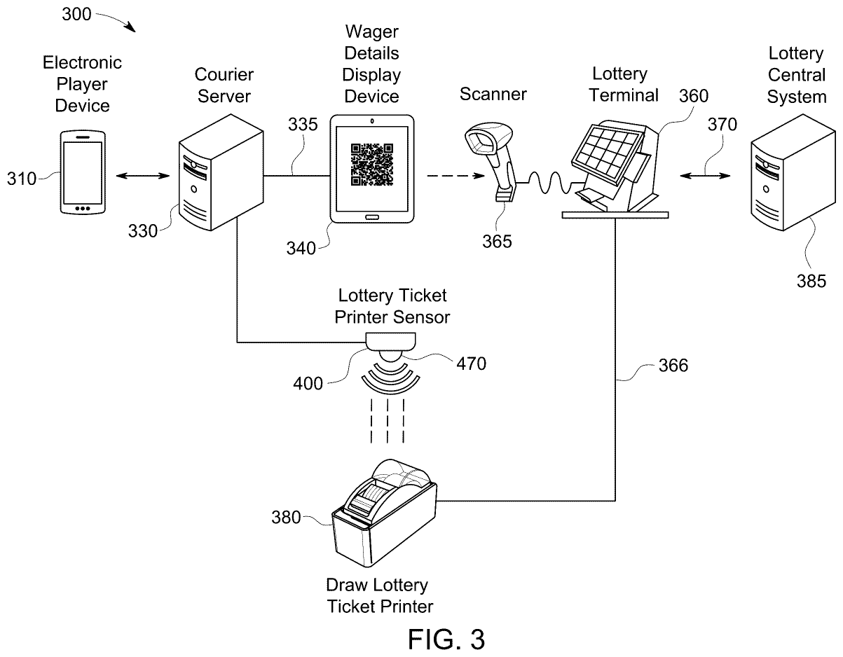

Turning now to FIG. 3, an example lottery ticket selling system 300 in accordance with one example embodiment of the present disclosure is generally shown.

This illustrated example lottery ticket selling system 300 includes: (a) an electronic player device 310 with a courier mobile application downloaded thereon; (b) an electronic ticket courier server 330; (c) a wager details display device 340; (d) a lottery terminal 360 with an associated scanner 365; (e) a draw lottery ticket printer 380; (f) a lottery central system 385; and (g) a lottery ticket printer sensor 400.

In this illustrated example embodiment, the electronic player device 310 and the courier server 330 are configured to communicate with each other via a suitable data network 320.

In this illustrated example embodiment, the courier server 330 and the wager details display device 340 are configured to communicate with each other via a network wire connection 335. In other embodiments, the communication between these components can be via hard wire, or other suitable data connection.

In this illustrated example embodiment, the lottery terminal 360 and the draw lottery ticket printer 380 are configured to communicate with each other via hard wire 366 such as an USB connector. In other embodiments, the communication between these components can be via a suitable data network. In other embodiments, the draw lottery ticket printer 380 can be built into the same housing as the lottery terminal 360 and thus be physically connected by hard wires therein.

In this illustrated example embodiment, the lottery terminal 360 and the lottery central system 385 are configured to communicate with each other via a suitable data network 370 such as a secure data network.

Generally, the lottery ticket selling system 300: (1) enables a purchaser to employ the electronic player device 310 to order and purchase a draw lottery ticket for a play of a draw lottery game; (2) causes the electronic player device 310 to send an order including the wager details for the purchase of the draw lottery ticket to the courier server 330; (3) causes the courier server 330 to generate a wager details code (such as a QR code) based on the wager details for the ordered draw lottery ticket to be purchased; (4) causes the courier server 330 to cause the wager details display device 340 to display the code to enable scanning of the code by the scanner 365 of the lottery terminal 360 to enable the lottery terminal 360 to obtain the wager details for the ordered draw lottery ticket to be purchased; (5) causes generation of the draw lottery ticket based on the wager details; (6) generates and sends the draw lottery ticket data to the lottery central system 385; and (7) causes the draw lottery ticket printer 380 to print the purchased draw lottery ticket T.

The present disclosure addresses the specific issue of ensuring that a physical draw lottery ticket is printed for each displayed wager details code and thus each draw lottery ticket ordered for purchase. The present disclosure enables confirmation that each corresponding draw lottery ticket for each wager details code displayed by the wager details display device 340 is printed by the draw lottery ticket printer 380 before the wager details display device 340 removes the display of the wager details code for that ordered draw lottery ticket and displays a wager details code for a next ordered draw lottery ticket to purchased and to be printed by the system 300. Generally, after the lottery ticket printer sensor 400 detects the printing of the draw lottery ticket (corresponding to a wager details code) by the draw lottery ticket printer 380, the lottery ticket printer sensor 400 sends a signal to the courier server 330 that confirms that the draw lottery ticket was printed. The courier server 330 can then cause the display by the wager details display device 340 of the code for a next ordered draw lottery ticket being purchased via the system 300. In alternative embodiments, after the lottery ticket printer sensor 400 detects the printing of the draw lottery ticket (corresponding to a wager details code) by the draw lottery ticket printer 380, the lottery ticket printer sensor 400 sends a signal to the wager details display device 340 that confirms that the draw lottery ticket was printed. The wager details display device 340 can then remove the display of the code for that printed draw lottery ticket and can then cause the display of the code for the next ordered draw lottery ticket being purchased via the system 300 that it has received from the courier server 330. These configurations enable the system 300 to process multiple draw lottery ticket purchase orders from multiple electronic player devices, que the codes for such ordered draw lottery tickets, and ensure that each draw lottery ticket is printed.

In various embodiments, the lottery ticket printer sensor 400 is positioned to sense one or more of: (1) a draw lottery ticket exits a part of the draw lottery ticket printer 380; (2) the draw lottery ticket after it exits the part of the draw lottery ticket printer 380; (3) the draw lottery ticket held by the draw lottery ticket printer 380 after being printed; and/or (4) one or more of the actions of the draw lottery ticket printer when or after the draw lottery ticket printer 380 prints the draw lottery ticket.

In various embodiments, the lottery ticket printer sensor 400 includes one or more optical sensors that is/are configured to optically detect the physical print draw lottery ticket exits part of the draw lottery ticket printer 380.

In various embodiments, the lottery ticket printer sensor 400 includes one or more optical sensors that is/are configured to optically detect an indicator (such as an LED light) of the draw lottery ticket printer 380 that indicates (such as by being illuminated) the printing of the draw lottery ticket by the draw lottery ticket printer 380.

In various embodiments, the lottery ticket printer sensor 400 includes one or more motion sensors that is/are configured to detect the motion of the physical print draw lottery ticket exits part of the draw lottery ticket printer 380.

In various embodiments, the lottery ticket printer sensor 400 includes one or more vibration sensors that is/are configured to detect vibration of the draw lottery ticket printer when the draw lottery ticket printer 380 prints the draw lottery ticket.

In various embodiments, the lottery ticket printer sensor 400 includes one or more contact sensors that is/are configured to detect the physical printed draw lottery ticket exits part of the draw lottery ticket printer 380 via contact of that ticket with part of the sensor.

In various embodiments, the lottery ticket printer sensor 400 includes two or more of these different types of sensors.

In various embodiments, the lottery ticket printer sensor 400 senses the paper exits part of the draw lottery ticket printer when or after the draw lottery ticket printer 380 prints the draw lottery ticket.

In various embodiments, the lottery ticket printer sensor 400 senses one or more of the actions of the draw lottery ticket printer when or after the draw lottery ticket printer 380 prints the draw lottery ticket.

In various embodiments, the lottery ticket printer sensor 400 senses the paper exiting part of the draw lottery ticket printer when or after the draw lottery ticket printer 380 prints the draw lottery ticket and/or one or more of the actions of the draw lottery ticket printer when or after the draw lottery ticket printer 380 prints the draw lottery ticket.

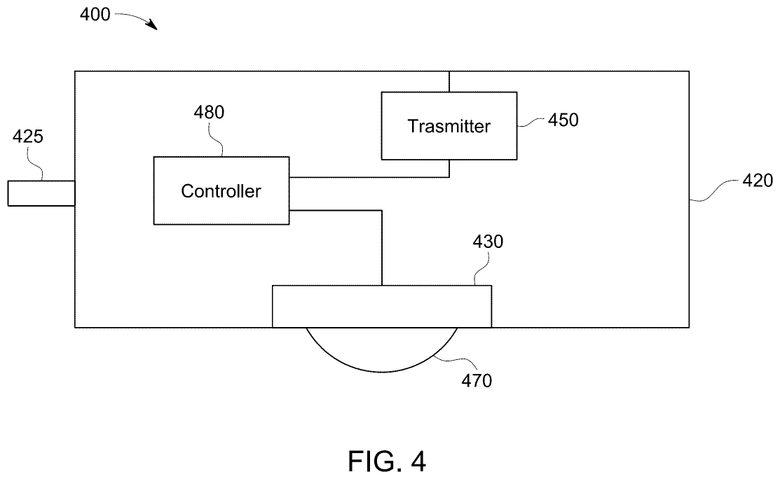

The lottery ticket printer sensor 400 of one example embodiment of the present disclosure is generally diagrammatically illustrated in FIGS. 3 and 4. This example is not meant to limit the present disclosure.

This illustrated example printer sensor 400 includes: (a) a housing 420; (b) an optical ticket sensor positioner 430 supported by the housing 400; (c) a power cord 425 supported by and extending from the housing 420; (d) a transmitter 450 supported by the housing 420; (e) an optical ticket sensor 470 supported by the optical ticket sensor positioner 430 and housing 420; (f) an onboard sensor controller 480 supported by the housing 420; and (g) one or more additional electrical or mechanical components (not shown) such as an on/off switch (not shown) supported by the housing 420. These electrical components are suitably electrically connected by the additional electrical components. Generally, these components and other suitable electrical and mechanical components are arranged or configured and electrically and/or mechanically connected such that when the lottery ticket printer sensor 400 can optically detect a printed draw lottery ticket printed by the draw lottery ticket printer 380 and send out one or more signals regarding the printing of such draw lottery ticket by the lottery ticket printer 380. The signals are sent to the courier server 330 in various embodiments. In other embodiments, the signals are sent to the wager details display device 340.

More specifically, the housing 420 includes a plurality of suitably connected walls (not labeled). It should be appreciated that any suitable housing can be employed in accordance with the present disclosure. The housing 420 and thus the sensor 400 can be positioned above the draw lottery ticket sensor 400 such as diagrammatically shown in FIG. 3 or can be positioned in another suitable position relative to the draw lottery ticket printer 380.

The optical ticket sensor positioner 430 includes one or more supports for the optical sensor 470, for connecting the optical sensor 470 to the housing 420, and for enabling positioning of the optical sensor in a direction pointing to the printed ticket deposit area and/or printed ticket holding area of the draw lottery ticket printer 380 that receives and temporarily holds each printed draw lottery ticket.

The transmitter 450 is positioned in and connected to the housing 420. The transmitter 450, in various embodiments, includes suitable components (not shown) for wirelessly transmitting signals to the courier server 330. Alternatively, the transmitter 450 is connected via a suitable hard wire (no shown) to the courier server 330. The transmitter 450 can be or include any suitable type of transmitting device. In certain embodiments of the present disclosure, the transmitter 450 is configured to only send out signals to the courier server 330. In other embodiments, the transmitter 450 is configured to send out and receive signals to the courier server 330. In other embodiments, the transmitter 450 is configured to send out and/or receive signals to/from the wager details display device 340.

The onboard sensor controller 480 is positioned in and suitably connected to the housing 420. It should be appreciated that the onboard sensor controller 480 can be any suitable type of automatic electrical or electronic computing device or circuit board. For example, in one example embodiment, the onboard controller includes a processor (such as a microprocessor) and a memory device. In another example embodiment, the onboard sensor controller includes an electric circuit hard wired to perform the necessary functions or determinations described herein. For this example embodiment, the onboard sensor controller 480 is configured to: (a) determine if the signal(s) from the optical sensor indicate(s) printing of a draw lottery ticket by the draw lottery ticket printer 380; and (b) cause the transmitter 450 to send out one or more signals indicating the printed ticket to the courier server 330 (or alternatively to the wager details display device 340).

It should be appreciated that in the alternative embodiment mentioned above where the lottery ticket printer sensor 400 sends the signals to the wager details display device 340 instead of the courier server 330, that the above described functions of sending, receiving, and processing the signals related to the printing of the draw lottery tickets by the draw lottery ticket printer would vary with respect to where these signals are sent and where these signals are received and acted upon. It should be appreciated that in the alternative embodiments mentioned above where the sensor sends the signals to the wager details display device instead of the courier server, that the wager details display device will include a suitable processor and memory device or another controller. In such embodiments, the wager details display device 340 will que the codes received from the courier server 330 and display each subsequent code after receiving confirmation from the lottery ticket printer 380 that indicates that the draw lottery ticket associated with the displayed code is printed.

In various alternative embodiments, the controller 480 is not part of the sensor 400 and is separate from the sensor 400.

It should be appreciated from the above that the present disclosure provides devices for confirming the printing of the draw lottery tickets by the draw lottery ticket printer 380 without changing the draw lottery ticket printer 380 or operation thereof.

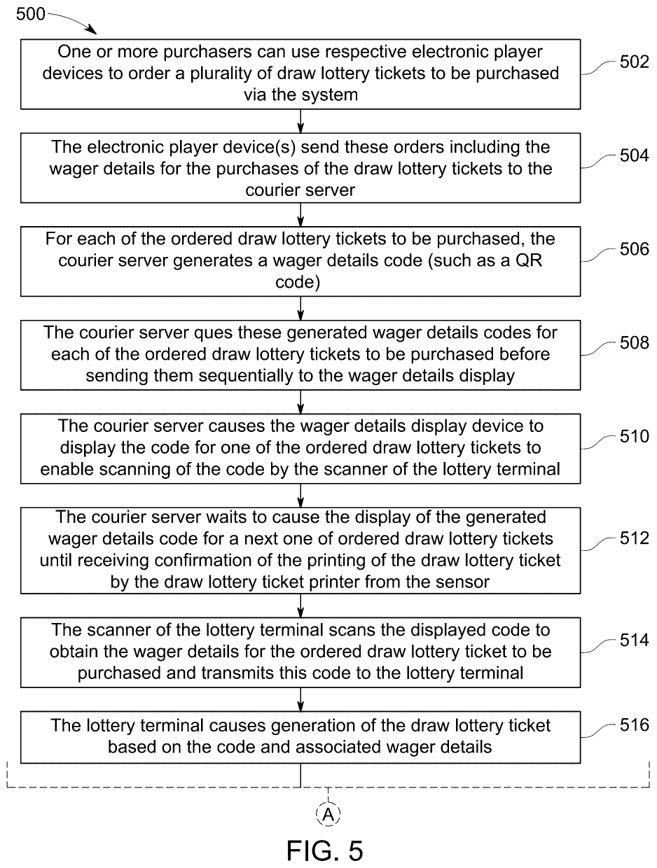

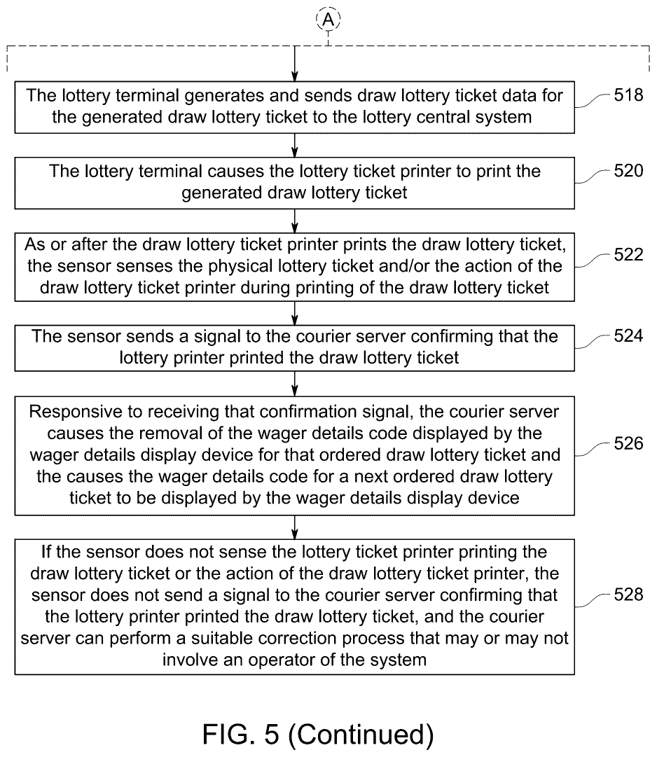

Various embodiments of present disclosure provide various methods of operating the systems of the present disclosure. FIG. 5 is a flowchart of an example method 500 of operating the system 300 of the present disclosure. In various embodiments, the method is represented by sets of instructions stored in the respective memories and executed by the respective processors. Although the method is described with reference to the flowchart shown in FIG. 5, many other processes of performing the acts associated with this illustrated method can be employed. For example, the order of certain of the illustrated blocks or diamonds can be changed, certain of the illustrated blocks or diamonds can be optional, or certain of the illustrated blocks or diamonds may not be employed.

One or more purchasers can use respective electronic player devices to order a plurality of draw lottery tickets to be purchased via the system, as indicated by block 502.

The electronic player device(s) send these orders including the wager details for the purchases of the draw lottery tickets to the courier server, as indicated by block 504.

For each of the ordered draw lottery tickets to be purchased, the courier server generates a wager details code (such as a QR code), as indicated by block 506.

The courier server ques these generated wager details codes for each of the ordered draw lottery tickets to be purchased before sending them sequentially to the wager details display, as indicated by block 508.

The courier server causes the wager details display device to display the code for one of the ordered draw lottery tickets to enable scanning of the code by the scanner of the lottery terminal, as indicated by block 510.

The courier server waits to cause the display of the generated wager details code for a next one of ordered draw lottery tickets until receiving confirmation of the printing of the draw lottery ticket by the draw lottery ticket printer from the sensor, as indicated by block 512.

The scanner of the lottery terminal scans the displayed code to obtain the wager details for the ordered draw lottery ticket to be purchased and transmits this code to the lottery terminal, as indicated by block 514.

The lottery terminal causes generation of the draw lottery ticket based on the code and associated wager details, as indicated by block 516.

The lottery terminal generates and sends draw lottery ticket data for the generated draw lottery ticket to the lottery central system, as indicated by block 518.

The lottery terminal causes the lottery ticket printer to print the generated draw lottery ticket, as indicated by block 520.

As or after the draw lottery ticket printer prints the draw lottery ticket, the sensor senses the physical lottery ticket and/or the action of the draw lottery ticket printer during printing of the draw lottery ticket, as indicated by block 522.

The sensor sends a signal to the courier server confirming that the lottery printer printed the draw lottery ticket, as indicated by block 524.

Responsive to receiving that confirmation signal, the courier server causes the removal of the wager details code displayed by the wager details display device for that ordered draw lottery ticket and the causes the wager details code for a next ordered draw lottery ticket to be displayed by the wager details display device, as indicated by block 526.

The process indicated by blocks 510 to 526 sequentially repeats for each ordered draw lottery ticket and each printed draw lottery ticket.

If the sensor does not sense the lottery ticket printer printing the draw lottery ticket or the action of the draw lottery ticket printer, the sensor does not send a signal to the courier server confirming that the lottery printer printed the draw lottery ticket, and the courier server can perform a suitable correction process that may or may not involve an operator of the system, as indicated by block 528. If the correction process involves an operator of the system, the courier server can cause an indication of the need for the correction process to the operator in any suitable manner.

It should be appreciated from the above that various embodiments of the present disclosure provide a lottery ticket selling system comprising: (1) a wager details display device; (2) a ticket courier server that responsive to receiving an order for a draw lottery ticket from an electronic player device with a courier mobile application, causes a display of a code associated with the draw lottery ticket by the wager details display device; (3) a lottery terminal and associated scanner; (4) a draw lottery ticket printer; and (5) a lottery ticket printer sensor comprising a sensor positioned to sense one of: (a) a draw lottery ticket exiting a part of the draw lottery ticket printer, (b) the draw lottery ticket after it exits the part of the draw lottery ticket printer, (c) the draw lottery ticket held by the draw lottery ticket printer, and (d) an action of the draw lottery ticket printer when or after the draw lottery ticket printer prints the draw lottery ticket. The lottery ticket printer sensor comprises a transmitter, a processor, and a memory device that stores a plurality of instructions, which when executed by the processor cause the processor to: receive a first signal from the sensor that indicates that the draw lottery printer printed the draw lottery ticket corresponding to the code, and send a second signal, via the transmitter, which indicates that the draw lottery ticket printer printed the draw lottery ticket and that causes a removal of the display of the code associated with that draw lottery ticket by the wager details display device. In various such embodiments, the lottery ticket printer sensor comprises an optical sensor positioned to optically sense the printed draw lottery ticket. In various such embodiments, the lottery ticket printer sensor comprises an optical sensor positioned to optically detect an indicator of the draw lottery ticket printer that indicates the printing of the draw lottery ticket by the draw lottery ticket printer. In various such embodiments, the lottery ticket printer sensor comprises an optical sensor positioned optically detect an indicator light of the draw lottery ticket printer that is illuminated when the draw lottery ticket is printed by the draw lottery ticket printer. In various such embodiments, the lottery ticket printer sensor comprises a motion sensor positioned to detect motion of the draw lottery ticket printed by the draw lottery ticket printer. In various such embodiments, the lottery ticket printer sensor comprises one or more vibration sensors that is/are configured to detect vibration of the draw lottery ticket printer when the draw lottery ticket printer prints the draw lottery ticket. In various such embodiments, the lottery ticket printer sensor comprises a contact sensor positioned to be contacted by the draw lottery ticket printed by the draw lottery ticket printer. In various such embodiments, the lottery ticket selling system includes a plurality of different types of lottery ticket printer sensors. In various such embodiments, the code associated with the draw lottery ticket is associated with wager details comprising player numbers, draw game and date, and player identification. In various such embodiments, the second signal causes the wager details display device to display another code associated with another draw lottery ticket after the removal of the display of the code associated with the draw lottery ticket by the wager details display device. In various such embodiments, the second signal causes the wager details display device to display another code associated with another draw lottery ticket as part of the removal of the display of the code associated with the draw lottery ticket by the wager details display device. In various such embodiments, the second signal causes the ticket courier server to cause the wager details display device to display another code associated with another draw lottery ticket after the ticket courier server causes the removal of the display of the code associated with the draw lottery ticket by the wager details display device. In various such embodiments, the second signal causes the ticket courier server to cause the wager details display device to display another code associated with another draw lottery ticket as part of the removal of the display of the code associated with the draw lottery ticket by the wager details display device.

It should further be appreciated from the above that various embodiments of the present disclosure provide a lottery ticket selling system comprising: (1) a wager details display device; (2) a ticket courier server that responsive to receiving an order for a draw lottery ticket, causes a display of a code associated with an ordered draw lottery ticket by the wager details display device; (3) a lottery terminal and associated scanner; (4) a draw lottery ticket printer; and (5) a lottery ticket printer sensor comprising a sensor, a transmitter, a processor, and a memory device that stores a plurality of instructions, which when executed by the processor cause the processor to: (a) receive a first signal from the sensor that indicates a physical sensing of the draw lottery printer printing a draw lottery ticket, and (b) send a second signal, via the transmitter, which indicates that the draw lottery ticket printer printed the draw lottery ticket and that causes a removal of the display of the code associated with that draw lottery ticket from the wager details display device. In various such embodiments, after the second signal is received by the ticket courier server, the ticket courier server causes the removal of the display of the code associated with that draw lottery ticket from the wager details display device. In various such embodiments, after the second signal is received by the ticket courier server, the ticket courier server causes the removal of the display of the code associated with that draw lottery ticket from the wager details display device, and a display of another code associated with another draw lottery ticket by the wager details display device. In various such embodiments, after the second signal is received by the wager details display device, the wager details display device causes the removal of the display of the code associated with that draw lottery ticket from the wager details display device. In various such embodiments, after the second signal is received by the wager details display device, the wager details display device causes the removal of the display of the code associated with that draw lottery ticket from the wager details display device, and a display of another code associated with another draw lottery ticket by the wager details display device. In various such embodiments, after the second signal is received by the wager details display device, the wager details display device causes the removal of the display of the code associated with that draw lottery ticket from the wager details display device, and a display of another code associated with another draw lottery ticket by the wager details display device received from the ticket courier server.

It should further be appreciated from the above that various embodiments of the present disclosure provide a lottery ticket selling system comprising: (1) a wager details display device; (2) a ticket courier server that responsive to receiving a first order for a first draw lottery ticket, causes a display of a first code associated with an ordered first draw lottery ticket by the wager details display device; (3) a lottery terminal and associated scanner; (4) a draw lottery ticket printer; and (5) a lottery ticket printer sensor comprising an optical sensor, a transmitter, a processor, and a memory device that stores a plurality of instructions, which when executed by the processor cause the processor to: (a) receive a first signal from the optical sensor that indicates that the draw lottery printer printed a first draw lottery ticket associated with the first code; (b) send a second signal, via the transmitter, which indicates that the draw lottery ticket printer printed the first draw lottery ticket and that causes a removal of the display of the first code associated with that first draw lottery ticket by the wager details display device; (c) receive a third signal from the optical sensor that indicates that the draw lottery printer printed a second draw lottery ticket associated with the second code; and (d) send a fourth signal, via the transmitter, which indicates that the draw lottery ticket printer printed the second draw lottery ticket and that causes a removal a display of the second code associated with the second draw lottery ticket by the wager details display device.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket selling system comprising:
a wager details display device;
a ticket courier server that responsive to receiving an order for a draw lottery ticket from an electronic player device with a courier mobile application, causes a display of a code associated with the draw lottery ticket by the wager details display device;
a lottery terminal and associated scanner;
a draw lottery ticket printer; and
a lottery ticket printer sensor comprising a sensor positioned to sense one of:
a draw lottery ticket exiting a part of the draw lottery ticket printer,
the draw lottery ticket after it exits the part of the draw lottery ticket printer,
the draw lottery ticket held by the draw lottery ticket printer, and
an action of the draw lottery ticket printer when or after the draw lottery ticket printer prints the draw lottery ticket,
wherein the lottery ticket printer sensor comprises a transmitter, a processor, and a memory device that stores a plurality of instructions, which when executed by the processor cause the processor to:
receive a first signal from the sensor that indicates that the draw lottery printer printed the draw lottery ticket corresponding to the code, and
send a second signal, via the transmitter, which indicates that the draw lottery ticket printer printed the draw lottery ticket and that causes a removal of the display of the code associated with that draw lottery ticket by the wager details display device.

2. The lottery ticket selling system of claim 1, wherein the lottery ticket printer sensor comprises an optical sensor positioned to optically sense the printed draw lottery ticket.

3. The lottery ticket selling system of claim 1, wherein the lottery ticket printer sensor comprises an optical sensor positioned to optically detect an indicator of the draw lottery ticket printer that indicates the printing of the draw lottery ticket by the draw lottery ticket printer.

4. The lottery ticket selling system of claim 1, wherein the lottery ticket printer sensor comprises an optical sensor positioned optically detect an indicator light of the draw lottery ticket printer that is illuminated when the draw lottery ticket is printed by the draw lottery ticket printer.

5. The lottery ticket selling system of claim 1, wherein the lottery ticket printer sensor comprises a motion sensor positioned to detect motion of the draw lottery ticket printed by the draw lottery ticket printer.

6. The lottery ticket selling system of claim 1, wherein the lottery ticket printer sensor comprises one or more vibration sensors that is/are configured to detect vibration of the draw lottery ticket printer when the draw lottery ticket printer prints the draw lottery ticket.

7. The lottery ticket selling system of claim 1, wherein the lottery ticket printer sensor comprises a contact sensor positioned to be contacted by the draw lottery ticket printed by the draw lottery ticket printer.

8. The lottery ticket selling system of claim 1, which comprises a plurality of different types of lottery ticket printer sensors.

9. The lottery ticket selling system of claim 1, wherein the code associated with the draw lottery ticket is associated with wager details comprising player numbers, draw game and date, and player identification.

10. The lottery ticket selling system of claim 1, wherein the second signal causes the wager details display device to display another code associated with another draw lottery ticket after the removal of the display of the code associated with the draw lottery ticket by the wager details display device.

11. The lottery ticket selling system of claim 1, wherein the second signal causes the wager details display device to display another code associated with another draw lottery ticket as part of the removal of the display of the code associated with the draw lottery ticket by the wager details display device.

12. The lottery ticket selling system of claim 1, wherein the second signal causes the ticket courier server to cause the wager details display device to display another code associated with another draw lottery ticket after the ticket courier server causes the removal of the display of the code associated with the draw lottery ticket by the wager details display device.

13. The lottery ticket selling system of claim 1, wherein the second signal causes the ticket courier server to cause the wager details display device to display another code associated with another draw lottery ticket as part of the removal of the display of the code associated with the draw lottery ticket by the wager details display device.

14. A lottery ticket selling system comprising:
a wager details display device;
a ticket courier server that responsive to receiving an order for a draw lottery ticket, causes a display of a code associated with an ordered draw lottery ticket by the wager details display device;
a lottery terminal and associated scanner;
a draw lottery ticket printer; and
a lottery ticket printer sensor comprising a sensor, a transmitter, a processor, and a memory device that stores a plurality of instructions, which when executed by the processor cause the processor to:
receive a first signal from the sensor that indicates a physical sensing of the draw lottery printer printing a draw lottery ticket, and
send a second signal, via the transmitter, which indicates that the draw lottery ticket printer printed the draw lottery ticket and that causes a removal of the display of the code associated with that draw lottery ticket from the wager details display device.

15. The lottery ticket selling system of claim 14, wherein after the second signal is received by the ticket courier server, the ticket courier server causes the removal of the display of the code associated with that draw lottery ticket from the wager details display device.

16. The lottery ticket selling system of claim 14, wherein after the second signal is received by the ticket courier server, the ticket courier server causes the removal of the display of the code associated with that draw lottery ticket from the wager details display device, and a display of another code associated with another draw lottery ticket by the wager details display device.

17. The lottery ticket selling system of claim 14, wherein after the second signal is received by the wager details display device, the wager details display device causes the removal of the display of the code associated with that draw lottery ticket from the wager details display device.

18. The lottery ticket selling system of claim 14, wherein after the second signal is received by the wager details display device, the wager details display device causes the removal of the display of the code associated with that draw lottery ticket from the wager details display device, and a display of another code associated with another draw lottery ticket by the wager details display device.

19. The lottery ticket selling system of claim 14, wherein after the second signal is received by the wager details display device, the wager details display device causes the removal of the display of the code associated with that draw lottery ticket from the wager details display device, and a display of another code associated with another draw lottery ticket by the wager details display device received from the ticket courier server.

20. A lottery ticket selling system comprising:
a wager details display device;
a ticket courier server that responsive to receiving a first order for a first draw lottery ticket, causes a display of a first code associated with an ordered first draw lottery ticket by the wager details display device;
a lottery terminal and associated scanner;
a draw lottery ticket printer; and
a lottery ticket printer sensor comprising an optical sensor, a transmitter, a processor, and a memory device that stores a plurality of instructions, which when executed by the processor cause the processor to:
receive a first signal from the optical sensor that indicates that the draw lottery printer printed a first draw lottery ticket associated with the first code;
send a second signal, via the transmitter, which indicates that the draw lottery ticket printer printed the first draw lottery ticket and that causes a removal of the display of the first code associated with that first draw lottery ticket by the wager details display device;
receive a third signal from the optical sensor that indicates that the draw lottery printer printed a second draw lottery ticket associated with the second code; and
send a fourth signal, via the transmitter, which indicates that the draw lottery ticket printer printed the second draw lottery ticket and that causes a removal a display of the second code associated with the second draw lottery ticket by the wager details display device.
